(19) United States
(12) Patent Application Publication
(10) Pub. No.: US 2025/0220458 A1
(43) Pub. Date: Jul. 3, 2025

(54) SYSTEMS AND METHODS FOR DYNAMIC LOCAL NETWORK POLICIES BASED ON ACCESS NETWORK METRICS

(71) Applicant: Verizon Patent and Licensing Inc., Basking Ridge, NJ (US)

(72) Inventors: Ratul K. Guha, Warwick, PA (US); Zainab Ababri, Dallas, TX (US); Edmond K. Chan, New Hope, PA (US)

(73) Assignee: Verizon Patent and Licensing Inc., Basking Ridge, NJ (US)

(21) Appl. No.: 18/401,679

(22) Filed: Jan. 1, 2024

(51) Int. Cl. H04W 24/02; H04W 24/08

(52) U.S. Cl. CPC H04W 24/02; H04W 24/08

(57) ABSTRACT

A system described herein may monitor Key Performance Indicators (“KPIs”) of a radio access network (“RAN”) that implements a first radio access technology (“RAT”), such as a Fifth Generation (“5G”) RAT. The system may determine, based on monitoring the KPIs of the RAN, that a particular RAN condition has occurred, and may notify a Fixed Wireless Access (“FWA”) device, that is wirelessly connected to the RAN via the first RAT and that is also wirelessly connected to a plurality of client devices via a second RAT, such as a WiFi RAT, that the particular RAN condition has occurred. The FWA device may implement one or more policies for communications between the FWA device and the plurality of client devices based on receiving the notification that the particular RAN condition has occurred.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. Fixed Wireless Access (“FWA”) devices may connect to one wireless network and may implement a second wireless network via which the FWA devices provide wireless connectivity to other devices. For example, an FWA device (e.g., a “hotspot” device) may connect to a wireless network via a Fifth Generation (“5G”) connection, and may implement a private or local WiFi network to which other devices connect. The FWA device may send and receive traffic to and from the devices via the WiFi network, and may route, forward, etc. such traffic to or from another network (e.g., a core network, the Internet, etc.) via the 5G connection.

### BRIEF DESCRIPTION OF THE DRAWINGS

FIG. 1 illustrates an example overview of one or more embodiments described herein;

FIG. 2 illustrates example data structures that may be used in accordance with one or more embodiments;

FIG. 3 illustrates an example process for causing one or more FWA devices to implement policies with respect to connections with respective client devices based on detected conditions associated with RAN, in accordance with some embodiments;

FIGS. 4 and 5 illustrate example environments in which one or more embodiments, described herein, may be implemented;

FIG. 6 illustrates an example arrangement of a radio access network (“RAN”), in accordance with some embodiments;

FIG. 7 illustrates an example arrangement of an Open RAN (“O-RAN”) environment in which one or more embodiments, described herein, may be implemented; and

FIG. 8 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide for control of a second network based on metrics, Key Performance Indicators (“KPIs”), and/or other attributes of a first network, where the second network is connected to the first network. Such embodiments may apply in scenarios where an FWA device provides connectivity through the first network to devices connected to a second network implemented by the FWA device. Such embodiments may facilitate efficient operation of the second network, such as by aiding in congestion management. For example, if congestion is detected on the first network, the second network may, in accordance with some embodiments, take congestion management actions in a manner that may optimize user experience for devices using the second network and/or may help reduce the cause of the congestion condition in the first network.

In some embodiments, the first and second networks may implement different radio access technologies (“RATs”), such as a 5G RAT, a Long-Term Evolution (“LTE”) RAT, or a WiFi RAT. In some embodiments, the two networks may use different types of radio frequencies for communications, such as licensed frequencies or unlicensed frequencies. Licensed frequencies are radio frequencies a governmental entity has granted exclusive use by a network operator via a license granted to the network operator. Unlicensed frequencies are radio frequencies that have been designated by a governmental entity as usable by multiple entities. Unlicensed frequencies may be subject to sharing requirements between different network operators. In some embodiments, the two networks may use different radio frequency “bands” or “sub-bands” (i.e., ranges of radio frequencies that have been grouped and labeled for administrative or ease-of-reference purposes), such as the “sub-6 Ghz” range and the “millimeter wave” range. In some implementations, a 5G RAT or LTE RAT with licensed frequencies in the sub-6 GHZ range may be used to implement a wide area network and a Wi-Fi RAT with unlicensed frequencies also in the sub-6 Ghz range may be used to implement a local area network. However, other implementations are possible, such as using a 5G RAT or LTE RAT with licensed or unlicensed frequencies to implement a private or local network, and/or using a 5G RAT over the sub-6 GHZ range for a wide area network and a 5G RAT over the millimeter wave range for a local area network.

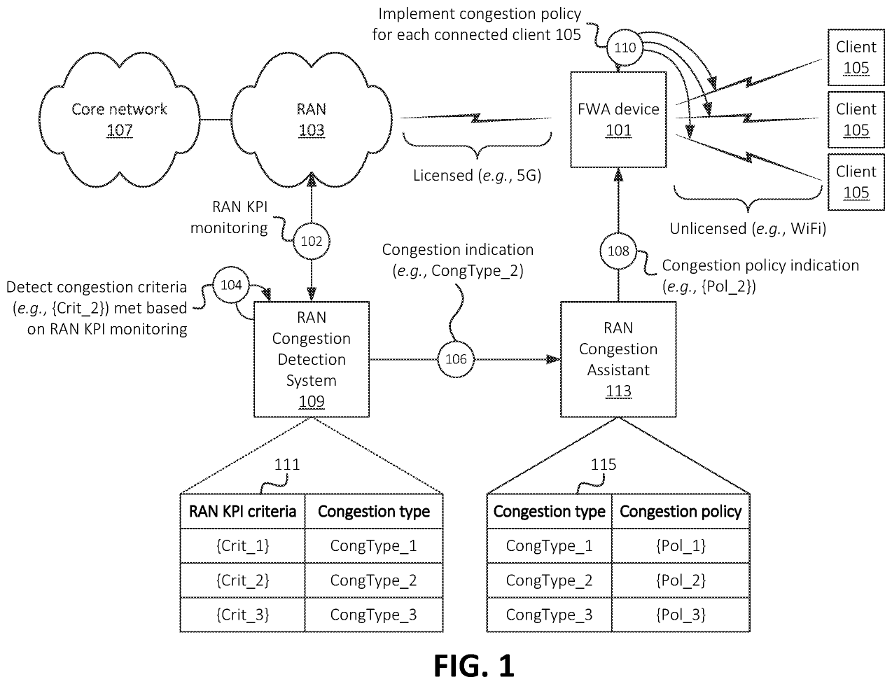

FIG. 1 provides one example implementation scenario, for which the concepts shown in FIG. 1 may also apply to other possible implementation scenarios. As shown in FIG. 1, FWA device 101 may be connected to a first network (e.g., RAN 103) via a first wireless RAT, such as a 5G RAT. As further shown, FWA device 101 may implement a second network (e.g., a private network, a local network, etc.) using a second wireless RAT, such as a WiFi RAT. For example, FWA device 101 may include a first set of radios, antennas, etc. that operate according to the first wireless RAT and may include a second set of radios, antennas, etc. that operating according to the second wireless RAT. FWA device 101 may include or may implement a router, firewall, hub, switch, etc. via which FWA device 101 routes traffic between client devices 105 (e.g., tablet computers, IoT devices, laptop computers, etc.) and RAN 103. In this sense, FWA device 101 may “share” its connection to RAN 103 with client devices 105 that communicate with FWA device 101 via the second RAT. FWA device 101 may be, may include, etc. a “hotspot” or other similar type of device.

Although examples discussed herein are provided in the context of FWA devices that implement a local network via a WiFi RAT, similar concepts may apply to FWA devices that implement the second network using a 5G RAT or LTE RAT. For example, such FWA devices may implement a local, private or “micro” network (e.g., a microcell, a picocell, a femtocell, a small cell, or the like) as the second network using the 5G RAT or LTE RAT (e.g., using licensed or unlicensed frequencies), while connecting to a RAN (e.g., to a macrocell, a large cell, etc.) that also uses 5G RAT and/or LTE RAT for wide area network connectivity.

In some embodiments, FWA device 101 may be a UE, such as a mobile phone or other type of device that wirelessly connects to RAN 103, that implements FWA functionality (e.g., connects to client devices 105 and performs appropriate routing or forwarding between RAN 103 and client devices 105). RAN 103 may be communicatively coupled to core network 107, which may further route traffic on behalf of client devices 105 (e.g., may route traffic, from client devices 105, to their intended destinations via the Internet or one or more other networks, and may also route incoming traffic to client devices 105). FWA device 101 may comprise a single physical device, or may comprise multiple interconnected physical devices to provide the capabilities of the FWA device. For example, FWA device 101 may comprise a radio unit for communicating over the first network and a “gateway” that includes facilities such as Internet Protocol (“IP”) routing, firewalling and port forwarding, Ethernet switching, and a radio unit for communicating over the second network.

As shown, in accordance with some embodiments, RAN Congestion Detection System (“RCDS”) 109 may monitor (at 102) one or more KPIs, metrics, statistics, etc. (hereinafter referred to simply as “KPIs” for the sake of brevity) associated with RAN 103. For example, RCDS 109 may monitor such information in real time or near-real time, such that RCDS 109 maintains up-to-date KPI information associated with RAN 103 (e.g., associated with particular base stations, cells, or other wireless network infrastructure equipment of RAN 103). Such KPI information may include information such as a quantity of UEs or other types of devices currently connected to RAN 103 (e.g., currently connected to a particular base station, a particular cell, a particular sector, etc. of RAN 103), an amount of utilized or available radio resources (e.g., Physical Resource Blocks (“PRBs”)) of RAN 103, performance metrics (e.g., uplink and/or downlink latency and/or throughput of communications between RAN 103 and connected devices, jitter of communications between RAN 103 and connected devices, etc.), signal strength information (e.g., Signal-to-Interference-and-Noise-Ratio (“SINR”) values, Received Signal Strength Indicator (“RSSI”) values, etc. as measured by RAN 103 and/or by devices connected to RAN 103), and/or other suitable KPIs. In general, the KPIs may be used to determine the condition or connection quality of RAN 103, such as whether RAN 103 is congested, is operating within acceptable parameters, etc.

RCDS 109 may monitor (at 102) the KPIs of RAN 103 by communicating with one or more elements of RAN 103 or some other suitable device or system that determines KPI information of RAN 103. For example, in some embodiments, RCDS 109 may communicate with a RAN controller, an orchestration system of a virtualized environment in which RAN 103 is implemented, and/or some other device or system that is included in or is communicatively coupled to RAN 103 and that provides the RAN KPI information to RCDS 109. In some embodiments, RCDS 109 may receive RAN KPI information from some other suitable source, such as an element of core network 107 (e.g., a Service Capability Exposure Function (“SCEF”), a Network Exposure Function (“NEF”), a RAN controller such as RAN Intelligent Controller (“RIC”), etc.) and/or some other suitable device or system. In some embodiments, the KPI information may be “pushed” to RCDS 109 on a periodic basis, on an event-driven basis (e.g., when RAN 103 or other suitable device or system detects that certain conditions or criteria are met), and/or on some other suitable basis. Additionally, or alternatively, RCDS 109 may “pull” the KPI information by requesting the KPI information on a periodic basis or some other suitable basis.

RCDS 109 may be implemented as a standalone system connected to core network 107 and/or RAN 103, or may be implemented as a network element (or a component of a network element) of core network 107 or RAN 103. For example, RCDS may be implemented as a network function within core network 107, as a service within a core network function such as an Access and Mobility Function (“AMF”), as part of a Next Generation Node B (“gNB”) (e.g., in a central unit (“CU”) or distributed unit (“DU”)), within an edge computing device connected to a RAN, or other locations.

As further shown, RCDS 109 may maintain data structure 111, which may associate various RAN KPI criteria with respective congestion types. RCDS 109 may, for example, receive some or all of the information shown in data structure 111 from an administrator, an operator of RAN 103 and/or core network 107, one or more network elements of RAN 103 and/or core network 107 (e.g., an AMF, a Policy Control Function (“PCF”), etc.), and/or some other suitable source. In some embodiments, RCDS 109 or some other device or system may generate or refine some or all of the information shown in data structure 111 using artificial intelligence/machine learning (“AI/ML”) techniques or other types of techniques, in which associations between RAN KPI criteria and respective congestion types are identified or refined.

The term “congestion” is used herein as a term to signify scenarios in which potential disruptions may be indicated by the RAN KPIs, such as a relatively large quantity (e.g., above a threshold quantity) of connected UEs to a given base station of RAN 103, a relatively low quantity or proportion (e.g., below a threshold quantity or proportion) of available radio resources, a relatively low measure of performance (e.g., relatively low throughput or relatively high latency), or the like. Although shown as a table, data structure 111 may represent other types of representations of associations between particular sets of RAN KPIs or criteria thereof, and types of congestion. Such other types of representations may include models (e.g., AI/ML models, statistical models, or other types of models), databases, or other suitable representations.

In this example, a first set of RAN KPI criteria (“{Crit_1}”) may be associated with a first type of congestion (“CongType_1”), a second set of RAN KPI criteria (“{Crit_2}”) may be associated with a second type of congestion (“CongType_2”), and so on. The RAN KPI criteria may include thresholds, values, etc. that may be compared to KPIs received (at 102) by RCDS 109 as part of the monitoring of RAN 103 by RCDS 109. In some embodiments, one set of RAN KPI criteria may include one or more thresholds for a particular KPI, while thresholds associated with another set of RAN KPI criteria may not pertain to the same particular KPI. As one example, {Crit_1} may include a maximum latency threshold, while {Crit_2} may include a minimum throughput threshold (and may potentially not include any thresholds relating to latency). As another example, a respective set of RAN KPI criteria (e.g., {Crit_1}, {Crit_2}, and/or {Crit_3}) may include a maximum quantity of connected UEs threshold, a minimum available radio resources threshold, etc. In this sense, the detection of different KPI criteria, based on the RAN KPI monitoring (at 102), may indicate different types of congestion or other potential issues with RAN 103.

As further shown, RCDS 109 may at some point detect (at 104) a congestion condition with respect to RAN 103. As noted above, “congestion” is a term used herein to signify some sort of potential issue with RAN 103, which may be indicated by one or more of the RAN KPI criteria (discussed above with respect to data structure 111) being met. In this example, RCDS 109 may determine that a particular set of RAN KPI criteria (i.e., {Crit_2} in this example) has been met, and therefore that a particular type of congestion (i.e., CongType_2) is present. In some embodiments, the detection by RCDS 109 may be based on determining that one or more actual values of the RAN KPIs exceed one or more thresholds indicated by {Crit_2}. Additionally, or alternatively, RCDS 109 may utilize predictive techniques to identify, based on monitored values (e.g., historical monitored values, values included in trained AI/ML models, etc.), that one or more thresholds indicated by {Crit_2} are likely (e.g., with at least a threshold measure of likelihood) to be met at some future time.

In some embodiments, RCDS 109 may detect (at 104) congestion conditions as they relate to particular FWA devices 101. For example, the particular FWA device 101 may be connected through a particular sector of RAN 103 that is experiencing potential connectivity or congestion issues (e.g., a relatively large quantity of connected UEs, a relatively low amount of available radio resources, etc.), and may identify that a congestion condition is applicable to the particular FWA device 101. On the other hand, RCDS 109 may also monitor other sectors of RAN 103 and may identify that a second sector of RAN 103 is not experiencing a congestion condition. In this situation, RCDS 109 may not detect that a congestion condition has occurred with respect to the second sector.

Based on detecting (at 104) that the particular congestion condition (e.g., {Crit_2}) has been met, RCDS 109 may output (at 106) a congestion indication to FWA device 101. In some embodiments, a RAN Congestion Assistant (“RCA”) 113 may be used by FWA device 101 to handle congestion management communications. RCA 113 may, for example, be communicatively coupled to or implemented by FWA device 101. For example, RCA 113 may be a device or system that is separate from FWA device 101 and is communicatively coupled to FWA device 101 via a wired or wireless connection. Additionally, or alternatively, RCA 113 may be implemented via one or more applications, application programming interfaces (“APIs”), operating system services, etc. executing at FWA device 101. In such embodiments, RCDS 109 and RCA 113 may communicate via RAN 103 or some other suitable communication pathway. Additionally, or alternatively, RCDS 109 and RCA 113 may be implemented by the same device or system, and/or may communicate via some suitable communication pathway other than RAN 103 (e.g., via the Internet, via another network, via a direct connection, etc.). In some embodiments, RCDS 109 and RCA 113 may communicate using Open Mobile Alliance Device Management (“OMA DM”) protocol communications over the connection to RAN 103, where the RCDS 109 acts as an OMA DM server and the RCA 113 acts as an OMA DM client.

As discussed above, situations may arise in which one portion of RAN 103 (e.g., a first sector) is experiencing a congestion condition, while other portions of RAN 103 (e.g., a second sector) are not experiencing congestion conditions. As such, RCDS 109 may indicate (at 106) a congestion condition to respective RCAs 113 associated with FWA devices 101 that are connected through the first sector, but may forgo notifying other devices or systems (e.g., other FWA devices 101 or associated RCAs 113) that are connected to the second sector. In this manner, RCDS 109 may provide focused notifications that are applicable to the specific conditions that apply to particular FWA devices 101.

In some embodiments, the congestion indication, from RCDS 109 to RCA 113, may include an indication of the particular detected type of congestion (i.e., CongType_2 in the example of FIG. 1). RCA 113 may maintain data structure 115, which includes information associating particular congestion types to different sets of congestion policies. The information included in data structure 115 may have been received from RCDS 109, from an administrator or operator of RAN 103 and/or core network 107, and/or some other suitable source. In some embodiments, RCDS 109 and/or other elements in core network 107 may provide the congestion policies to RCA 113 over RAN 103 prior to RCDS 109 providing congestion indications to FWA device 101. In some embodiments, the congestion policies may be sent to FWA device 101 as an OMA DM message. In some embodiments, the congestion policies may be sent to FWA device 101 as part of a device configuration process or device policy update. In some embodiments, RCA 113 and/or some other device or system may generate or refine data structure 115 using AI/ML techniques or other suitable techniques. Generally, the association of a particular congestion type with a respective set of congestion polices may be determined such that the user experience or performance of client devices 105 is of a minimal or zero negative impact in situations where RAN 103 is congested (or where the performance of communications between FWA device 101 and RAN 103 is otherwise negatively impacted).

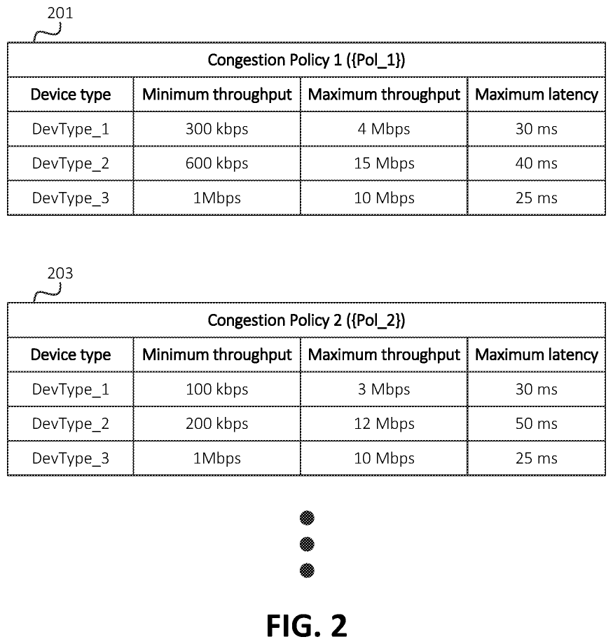

FIG. 2 illustrates an example of different sets of congestion policies that are associated with respective congestion types. For example, data structure 201 may reflect a first example set of congestion policies (e.g., {Pol_1}), data structure 203 may reflect a second set of congestion policies, and so on. In these examples, congestion policies are specified on the basis of device or application type. Device type may refer to, for example, types such as mobile phone, smart television, tablet, wearable device, IoT device, or the like. In some embodiments, application type may refer to some other type of category, classification, usage or service type (e.g., “voice call services,” “gaming services,” “video services,” or the like), or some other descriptor or attributes of a given client device 105 or of traffic sent to or from such client device 105. As used herein, “traffic type” generally refers to a device type or application type.

The congestion policies indicated in data structure 201 may reflect policies to apply when a first congestion type is indicated (e.g., CongType_1), congestion policies indicated in data structure 203 may reflect policies to apply when a second congestion type is indicated (e.g., CongType_2), and so on. In this manner, different sets of congestion policies may apply in different congestion scenarios, as applying such policies may remediate the particular issues (e.g., preserve the user experience) associated with each different congestion scenario. For example, reducing maximum throughput for one traffic type may be an appropriate remedial measure for one congestion scenario (e.g., one congestion type), while increasing minimum throughput for another traffic type may be an appropriate remedial measure for another congestion scenario.

The example congestion policies shown in FIG. 2 include minimum throughput, maximum throughput, and maximum latency. In some embodiments, congestion policies may include additional, fewer, and/or different types of policies or thresholds. As discussed below, the congestion policies may relate to communications between FWA device 101 and respective client devices 105. In this manner, FWA device 101 may configure connectivity between FWA device 101 and client devices 105 (e.g., in accordance with an indicated congestion policy) in a manner that preserves the user experience of client devices 105 when communications between FWA device 101 and RAN 103 exhibit connectivity issues.

Returning to FIG. 1, RCA 113 may provide (at 108) a congestion policy indication to FWA device 101, based on receiving (at 106) a notification of the particular type of congestion as detected (at 104) by RCDS 109. For example, RCA 113 may provide the congestion policy indications via an API or other suitable communication pathway, to indicate that FWA device 101 should implement a particular set of congestion policies (i.e., {Pol_2}, in this example). In some embodiments, FWA device 101 may maintain the congestion policies (e.g., data structures 201, 203, etc.), and RCA 113 may provide an index or identifier of a particular congestion policy to implement. In some embodiments, RCA 113 may provide the specific congestion policies to implement (e.g., may specify traffic types, threshold throughput and/or latency values, etc.). FWA device 101 may proceed to implement (at 110) the indicated congestion policy with respect to communications between FWA device 101 and client devices 105 over the second network (in this example, using the WiFi RAT).

For example, FWA device 101 may identify which particular client devices 105 are associated with which particular traffic types (or other suitable criteria) indicated in the congestion policy. FWA device 101 may, for example, identify a name or category of one or more client devices 105. For example, client devices 105 may implement a protocol (e.g., Universal Plug and Play (“UPnP”)) or other suitable technique whereby client devices 105 broadcast, advertise, etc. a respective device name or identifier. Additionally, or alternatively, client devices 105 or a user of FWA device 101 may have previously registered one or more client devices 105 with FWA device 101 as having a particular device type, category, classification, or other suitable information. In some embodiments, FWA device 101 may perform deep packet inspection (“DPI”), analyze header information, etc. of traffic sent between FWA device 101 and client devices 105 to identify types of services associated with client devices 105 (e.g., voice call services, gaming services, etc.), and may identify corresponding device types or categories of client devices 105 based on such analysis.

Implementing (at 110) the indicated congestion policy may include performing a congestion management action based on the traffic type. Congestion management actions may include prioritizing traffic associated with respective client devices 105 (e.g., to enforce maximum latency or minimum throughput thresholds indicated in the congestion policy), rate limiting specific traffic types (e.g., dropping traffic from a particular client device 105 that exceeds a maximum throughput for a corresponding device type), and/or otherwise enforcing the congestion policy. That is, FWA device 101 may implement the congestion policy with respect to communications between FWA device 101 and respective client devices 105, such that connectivity issues between FWA device 101 and RAN 103 may be improved for at least some of the client devices 105. Since the congestion indications are provided (e.g., by RCDS 109) based on KPIs received from RAN 103, the remedial measures (e.g., implementation of an appropriate congestion policy) may be appropriately identified to closely match the specific type of issue exhibited by RAN 103. Further, since FWA device 101 does not necessarily have access to all KPIs of RAN 103 (e.g., does not necessarily have access to all of the KPIs monitored (at 102) by RCDS 109), RCDS 109 may be more capable of accounting for potential connectivity issues of RAN 103 (e.g., which may not necessarily be as detectable, or detectable as quickly, by FWA device 101).

In some implementations, FWA device 101 may implement a routing facility that implements the congestion policy on traffic associated with client devices 105. The routing facility may include a routing table that maps device addresses (e.g., IP addresses, Media Access Control (“MAC”) addresses, or other suitable addresses or identifiers) to categories and/or priority levels. The congestion policy may identify categories and/or priorities of the routing table in order to apply an appropriate congestion management mechanism based on traffic type. For example, the routing table may include WiFi QoS Management categories/priority values, and/or implementation-specific categories associated with a traffic type, and the congestion policy may include an indication of these categories/priorities with congestion management information that can be used to perform the congestion management action. In some implementations, the routing table may include Differentiated Services Control Point (“DSCP”) values used in marking device traffic, and the congestion policy may include an indication of these values with congestion management information that can be used to perform the congestion management action.

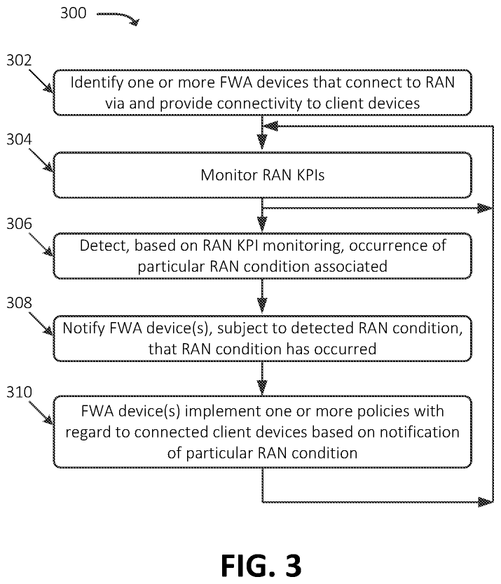

FIG. 3 illustrates an example process 300 for causing one or more FWA devices 101 to implement policies with respect to connections with respective client devices 105 based on detected conditions associated with RAN 103. In some embodiments, some or all of process 300 may be performed by RCDS 109 and/or RCA 113.

As shown, process 300 may include identifying (at 302) one or more FWA devices 101 that are connected to RAN 103. As discussed above, FWA devices 101 may connect to RAN 103 via a first RAT (e.g., a 5G RAT, an LTE RAT, etc.), and may provide connectivity via a second RAT (e.g., a WiFi RAT) to one or more client devices 105. For example, RAN 103 may be a first network to which a particular FWA device 101 is connected, and such FWA device 101 may further implement a second network to which respective client devices 105 are connected. RCDS 109 may, for example, receive information (e.g., from an administrator or operator of RAN 103 and/or core network 107) indicating particular FWA devices 101 that are connected to RAN 103. Such information may indicate particular portions of RAN 103 to which each FWA device 101 is connected (e.g., particular base stations, geographical regions, cells, sectors, etc.).

Process 300 may further include monitoring (at 304) RAN KPIs. For example, as discussed above, RCDS 109 may receive, from RAN 103 and/or from some other device or system, information indicating congestion metrics, load metrics, performance metrics, etc. associated with RAN 103. In some embodiments, the information may be granular to a per-base station basis, a per-cell basis, a per-sector basis, a per-region basis, etc. RCDS 109 may monitor the RAN KPIs on an ongoing basis, such that RCDS 109 is kept up-to-date on the state, performance, capacity, etc. of RAN 103.

Process 300 may additionally include detecting (at 306) an occurrence of a particular RAN condition, based on monitoring the RAN KPIs. For example, as discussed above, RCDS 109 may maintain information indicating particular criteria with which one or more types of RAN conditions are associated. RCDS 109 may compare such criteria to the monitored KPIs on an ongoing basis, such that RCDS 109 is able to ascertain when a particular set of criteria are met, which may indicate the occurrence (or the potential or predicted occurrence) of a particular RAN condition, such as a congestion condition, an overload condition, a performance degradation condition, etc.

Process 300 may also include notifying (at 308) one or more FWA devices 101, that are subject to the detected RAN condition, that the RAN condition has occurred. For example, as discussed above, RCDS 109 may identify particular FWA devices 101 that are connected through a particular sector, are located within a particular region, etc. with which the detected RAN condition is associated. For example, assuming that the detected RAN condition is associated with a first sector and not a second sector, RCDS 109 may notify a first FWA device 101 that is connected through the first sector and may forgo notifying a second FWA device 101 that is connected through the second sector. In some embodiments, RCDS 109 may notify one or more RCAs 113, which are each communicatively coupled to one or more respective FWA devices 101, of the detected RAN condition. In some embodiments, as discussed above, RCAs 113 may be separate devices or systems than FWA devices 101. In some embodiments, some or all of the functionality of a given RCA 113 may be implemented by a particular FWA device 101. As discussed above, the notification of the particular RAN condition may include an identification of the particular RAN condition, and/or may include some or all of the monitored RAN KPIs based on which the RAN condition was detected (e.g., RAN KPIs that exceed one or more threshold values, some or all RAN KPIs received in a particular time window preceding the detection of the RAN condition, etc.).

Process 300 may further include implementing (at 310), by the notified FWA devices 101, one or more policies with respect to connected client devices 105 based on the notification of the particular RAN condition. For example, a particular FWA device 101 and/or RCA 113 may identify a particular set of policies that are associated with the particular RAN condition as indicated by RCDS 109. In some embodiments, different types of RAN conditions may be associated with different ones of such policies. As discussed above, the policies may include maximum thresholds, minimum thresholds, and/or other types of policies relating to the prioritization and/or other treatment of traffic by client devices 105 connected to FWA device 101. The policies may include criteria based on which different client devices 105, different types of traffic or services sent or received by client devices 105, etc. may be prioritized or otherwise treated differently. In this sense, FWA device 101 may be able to take remedial action that is tailored to the particular type of RAN condition that has occurred with respect to RAN 103 to which FWA device 101 is connected. Further, the policies may be generated or refined (e.g., using AI/ML techniques or other suitable techniques) such that the user experience delivered via client devices 105 is impacted in a minimal or negligible manner.

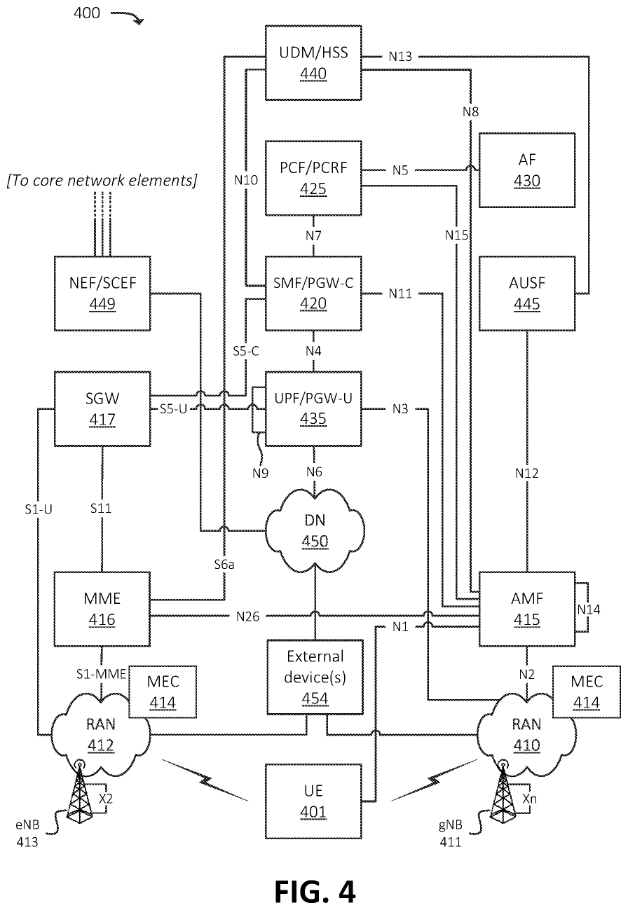

FIG. 4 illustrates an example environment 400, in which one or more embodiments may be implemented. In some embodiments, environment 400 may correspond to a 5G network, and/or may include elements of a 5G network. In some embodiments, environment 400 may correspond to a 5G Non-Standalone (“NSA”) architecture, in which a 5G RAT may be used in conjunction with one or more other RATs (e.g., an LTE RAT), and/or in which elements of a 5G core network may be implemented by, may be communicatively coupled with, and/or may include elements of another type of core network (e.g., an evolved packet core (“EPC”)). In some embodiments, portions of environment 400 may represent or may include a 5G core (“5GC”). As shown, environment 400 may include UE 401, RAN 410 (which may include one or more gNBs” 411), RAN 412 (which may include one or more evolved Node Bs (“eNBs”) 413), and various network functions such as AMF 415, Mobility Management Entity (“MME”) 416, Serving Gateway (“SGW”) 417, Session Management Function (“SMF”)/Packet Data Network (“PDN”) Gateway (“PGW”)-Control plane function (“PGW-C”) 420, PCF/Policy Charging and Rules Function (“PCRF”) 425, Application Function (“AF”) 430, User Plane Function (“UPF”)/PGW-User plane function (“PGW-U”) 435, Unified Data Management (“UDM”)/Home Subscriber Server (“HSS”) 440, Authentication Server Function (“AUSF”) 445, and NEF/SCEF 449. Environment 400 may also include one or more networks, such as Data Network (“DN”) 450. Environment 400 may include one or more additional devices or systems communicatively coupled to one or more networks (e.g., DN 450), such as one or more external devices 454.

The example shown in FIG. 4 illustrates one instance of each network component or function (e.g., one instance of SMF/PGW-C 420, PCF/PCRF 425, UPF/PGW-U 435, UDM/HSS 440, and/or AUSF 445). In practice, environment 400 may include multiple instances of such components or functions. For example, in some embodiments, environment 400 may include multiple “slices” of a core network, where each slice includes a discrete and/or logical set of network functions (e.g., one slice may include a first instance of AMF 415, SMF/PGW-C 420, PCF/PCRF 425, and/or UPF/PGW-U 435, while another slice may include a second instance of AMF 415, SMF/PGW-C 420, PCF/PCRF 425, and/or UPF/PGW-U 435). The different slices may provide differentiated levels of service, such as service in accordance with different Quality of Service (“QoS”) parameters.

The quantity of devices and/or networks, illustrated in FIG. 4, is provided for explanatory purposes only. In practice, environment 400 may include additional devices and/or networks, fewer devices and/or networks, different devices and/or networks, or differently arranged devices and/or networks than illustrated in FIG. 4. For example, while not shown, environment 400 may include devices that facilitate or enable communication between various components shown in environment 400, such as routers, modems, gateways, switches, hubs, etc. In some implementations, one or more devices of environment 400 may be physically integrated in, and/or may be physically attached to, one or more other devices of environment 400. Alternatively, or additionally, one or more of the devices of environment 400 may perform one or more network functions described as being performed by another one or more of the devices of environment 400.

Additionally, one or more elements of environment 400 may be implemented in a virtualized and/or containerized manner. For example, one or more of the elements of environment 400 may be implemented by one or more Virtualized Network Functions (“VNFs”), Cloud-Native Network Functions (“CNFs”), etc. In such embodiments, environment 400 may include, may implement, and/or may be communicatively coupled to an orchestration platform that provisions hardware resources, installs containers or applications, performs load balancing, and/or otherwise manages the deployment of such elements of environment 400. In some embodiments, such orchestration and/or management of such elements of environment 400 may be performed by, or in conjunction with, the open-source Kubernetes® API or some other suitable virtualization, containerization, and/or orchestration system.

Elements of environment 400 may interconnect with each other and/or other devices via wired connections, wireless connections, or a combination of wired and wireless connections. Examples of interfaces or communication pathways between the elements of environment 400, as shown in FIG. 4, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 4, such as Service-Based Interfaces (“SBIs”), including an Namf interface, an Nudm interface, an Npcf interface, an Nupf interface, an Nnef interface, an Nsmf interface, and/or one or more other SBIs. In some embodiments, environment 400 may be, may include, may be implemented by, and/or may be communicatively coupled to RAN 103 and/or core network 107.

UE 401 may include a computation and communication device, such as a wireless mobile communication device that is capable of communicating with RAN 410, RAN 412, and/or DN 450. UE 401 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a Machine-to-Machine (“M2M”) device, or the like), or another type of mobile computation and communication device. In some embodiments, FWA device 101 and/or one or more client devices 105 may be, may include, and/or may be implemented one or more UEs 401. UE 401 may send traffic to and/or receive traffic (e.g., user plane traffic) from DN 450 via RAN 410, RAN 412, and/or UPF/PGW-U 435.

RAN 410 may be, or may include, a 5G RAN that uses a 5G RAT and includes one or more base stations (e.g., one or more gNBs 411), via which UE 401 may communicate with one or more other elements of environment 400. UE 401 may communicate with RAN 410 via an air interface (e.g., as provided by gNB 411). For instance, RAN 410 may receive traffic (e.g., user plane traffic such as voice call traffic, data traffic, messaging traffic, etc.) from UE 401 via the air interface, and may communicate the traffic to UPF/PGW-U 435 and/or one or more other devices or networks. Further, RAN 410 may receive signaling traffic, control plane traffic, etc. from UE 401 via the air interface, and may communicate such signaling traffic, control plane traffic, etc. to AMF 415 and/or one or more other devices or networks. Additionally, RAN 410 may receive traffic intended for UE 401 (e.g., from UPF/PGW-U 435, AMF 415, and/or one or more other devices or networks) and may communicate the traffic to UE 401 via the air interface.

RAN 412 may be, or may include, an LTE RAN that uses an LTE RAT and that includes one or more base stations (e.g., one or more eNBs 413), via which UE 401 may communicate with one or more other elements of environment 400. UE 401 may communicate with RAN 412 via an air interface (e.g., as provided by eNB 413). For instance, RAN 412 may receive traffic (e.g., user plane traffic such as voice call traffic, data traffic, messaging traffic, signaling traffic, etc.) from UE 401 via the air interface, and may communicate the traffic to UPF/PGW-U 435 (e.g., via SGW 417) and/or one or more other devices or networks. Further, RAN 412 may receive signaling traffic, control plane traffic, etc. from UE 401 via the air interface, and may communicate such signaling traffic, control plane traffic, etc. to MME 416 and/or one or more other devices or networks. Additionally, RAN 412 may receive traffic intended for UE 401 (e.g., from UPF/PGW-U 435, MME 416, SGW 417, and/or one or more other devices or networks) and may communicate the traffic to UE 401 via the air interface.

One or more RANs of environment 400 (e.g., RAN 410 and/or RAN 412) may include, may implement, and/or may otherwise be communicatively coupled to one or more edge computing devices, such as one or more Multi-Access/Mobile Edge Computing (“MEC”) devices (referred to sometimes herein simply as a “MECs”) 414. MECs 414 may be co-located with wireless network infrastructure equipment of RANs 410 and/or 412 (e.g., one or more gNBs 411 and/or one or more eNBs 413, respectively). Additionally, or alternatively, MECs 414 may otherwise be associated with geographical regions (e.g., coverage areas) of wireless network infrastructure equipment of RANs 410 and/or 412. In some embodiments, one or more MECs 414 may be implemented by the same set of hardware resources, the same set of devices, etc. that implement wireless network infrastructure equipment of RANs 410 and/or 412. In some embodiments, one or more MECs 414 may be implemented by different hardware resources, a different set of devices, etc. from hardware resources or devices that implement wireless network infrastructure equipment of RANs 410 and/or 412. In some embodiments, MECs 414 may be communicatively coupled to wireless network infrastructure equipment of RANs 410 and/or 412 (e.g., via a high-speed and/or low-latency link such as a physical wired interface, a high-speed and/or low-latency wireless interface, or some other suitable communication pathway).

MECs 414 may include hardware resources (e.g., configurable or provisionable hardware resources) that may be configured to provide services and/or otherwise process traffic to and/or from UE 401, via RAN 410 and/or 412. For example, RAN 410 and/or 412 may route some traffic from UE 401 (e.g., traffic associated with one or more particular services, applications, application types, etc.) to a respective MEC 414 instead of to core network elements of 400 (e.g., UPF/PGW-U 435). MEC 414 may accordingly provide services to UE 401 by processing such traffic, performing one or more computations based on the received traffic, and providing traffic to UE 401 via RAN 410 and/or 412. MEC 414 may include, and/or may implement, some or all of the functionality described above with respect to RCDS 109, UPF/PGW-U 435, AF 430, one or more application servers, and/or one or more other devices, systems, VNFs, CNFs, etc. In this manner, ultra-low latency services may be provided to UE 401, as traffic does not need to traverse links (e.g., backhaul links) between RAN 410 and/or 412 and the core network.

AMF 415 may include one or more devices, systems, VNFs, CNFs, etc., that perform operations to register UE 401 with the 5G network, to establish bearer channels associated with a session with UE 401, to hand off UE 401 from the 5G network to another network, to hand off UE 401 from the other network to the 5G network, manage mobility of UE 401 between RANs 410 and/or gNBs 411, and/or to perform other operations. In some embodiments, the 5G network may include multiple AMFs 415, which communicate with each other via the N14 interface (denoted in FIG. 4 by the line marked “N14” originating and terminating at AMF 415).

MME 416 may include one or more devices, systems, VNFs, CNFs, etc., that perform operations to register UE 401 with the EPC, to establish bearer channels associated with a session with UE 401, to hand off UE 401 from the EPC to another network, to hand off UE 401 from another network to the EPC, manage mobility of UE 401 between RANs 412 and/or eNBs 413, and/or to perform other operations.

SGW 417 may include one or more devices, systems, VNFs, CNFs, etc., that aggregate traffic received from one or more eNBs 413 and send the aggregated traffic to an external network or device via UPF/PGW-U 435. Additionally, SGW 417 may aggregate traffic received from one or more UPF/PGW-Us 435 and may send the aggregated traffic to one or more eNBs 413. SGW 417 may operate as an anchor for the user plane during inter-eNB handovers and as an anchor for mobility between different telecommunication networks or RANs (e.g., RANs 410 and 412).

SMF/PGW-C 420 may include one or more devices, systems, VNFs, CNFs, etc., that gather, process, store, and/or provide information in a manner described herein. SMF/PGW-C 420 may, for example, facilitate the establishment of communication sessions on behalf of UE 401. In some embodiments, the establishment of communications sessions may be performed in accordance with one or more policies provided by PCF/PCRF 425.

PCF/PCRF 425 may include one or more devices, systems, VNFs, CNFs, etc., that aggregate information to and from the 5G network and/or other sources. PCF/PCRF 425 may receive information regarding policies and/or subscriptions from one or more sources, such as subscriber databases and/or from one or more users (such as, for example, an administrator associated with PCF/PCRF 425).

AF 430 may include one or more devices, systems, VNFs, CNFs, etc., that receive, store, and/or provide information that may be used in determining parameters (e.g., quality of service parameters, charging parameters, or the like) for certain applications.

UPF/PGW-U 435 may include one or more devices, systems, VNFs, CNFs, etc., that receive, store, and/or provide data (e.g., user plane data). For example, UPF/PGW-U 435 may receive user plane data (e.g., voice call traffic, data traffic, etc.), destined for UE 401, from DN 450, and may forward the user plane data toward UE 401 (e.g., via RAN 410, SMF/PGW-C 420, and/or one or more other devices). In some embodiments, multiple instances of UPF/PGW-U 435 may be deployed (e.g., in different geographical locations), and the delivery of content to UE 401 may be coordinated via the N9 interface (e.g., as denoted in FIG. 4 by the line marked “N9” originating and terminating at UPF/PGW-U 435). Similarly, UPF/PGW-U 435 may receive traffic from UE 401 (e.g., via RAN 410, RAN 412, SMF/PGW-C 420, and/or one or more other devices), and may forward the traffic toward DN 450. In some embodiments, UPF/PGW-U 435 may communicate (e.g., via the N4 interface) with SMF/PGW-C 420, regarding user plane data processed by UPF/PGW-U 435.

UDM/HSS 440 and AUSF 445 may include one or more devices, systems, VNFs, CNFs, etc., that manage, update, and/or store, in one or more memory devices associated with AUSF 445 and/or UDM/HSS 440, profile information associated with a subscriber. In some embodiments, UDM/HSS 440 may include, may implement, may be communicatively coupled to, and/or may otherwise be associated with some other type of repository or database, such as a Unified Data Repository (“UDR”). AUSF 445 and/or UDM/HSS 440 may perform authentication, authorization, and/or accounting operations associated with one or more UEs 401 and/or one or more communication sessions associated with one or more UEs 401.

DN 450 may include one or more wired and/or wireless networks. For example, DN 450 may include an IP-based PDN, a wide area network (“WAN”) such as the Internet, a private enterprise network, and/or one or more other networks. UE 401 may communicate, through DN 450, with data servers, other UEs 401, and/or to other servers or applications that are coupled to DN 450. DN 450 may be connected to one or more other networks, such as a public switched telephone network (“PSTN”), a public land mobile network (“PLMN”), and/or another network. DN 450 may be connected to one or more devices, such as content providers, applications, web servers, and/or other devices, with which UE 401 may communicate.

External devices 454 may include one or more devices or systems that communicate with UE 401 via DN 450 and one or more elements of 400 (e.g., via UPF/PGW-U 435). In some embodiments, external devices 454 may include, may implement, and/or may otherwise be associated with RCDS 109 and/or RCA 113. External devices 454 may include, for example, one or more application servers, content provider systems, web servers, or the like. External devices 454 may, for example, implement “server-side” applications that communicate with “client-side” applications executed by UE 401. External devices 454 may provide services to UE 401 such as gaming services, videoconferencing services, messaging services, email services, web services, and/or other types of services.

In some embodiments, external devices 454 may communicate with one or more elements of environment 400 (e.g., core network elements) via NEF/SCEF 449. NEF/SCEF 449 include one or more devices, systems, VNFs, CNFs, etc. that provide access to information, APIs, and/or other operations or mechanisms of one or more core network elements to devices or systems that are external to the core network (e.g., to external device 454 via DN 450). NEF/SCEF 449 may maintain authorization and/or authentication information associated with such external devices or systems, such that NEF/SCEF 449 is able to provide information, that is authorized to be provided, to the external devices or systems. For example, a given external device 454 may request particular information associated with one or more core network elements. NEF/SCEF 449 may authenticate the request and/or otherwise verify that external device 454 is authorized to receive the information, and may request, obtain, or otherwise receive the information from the one or more core network elements. In some embodiments, NEF/SCEF 449 may include, may implement, may be implemented by, may be communicatively coupled to, and/or may otherwise be associated with a Security Edge Protection Proxy (“SEPP”), which may perform some or all of the functions discussed above. External device 454 may, in some situations, subscribe to particular types of requested information provided by the one or more core network elements, and the one or more core network elements may provide (e.g., “push”) the requested information to NEF/SCEF 449 (e.g., in a periodic or otherwise ongoing basis).

In some embodiments, external devices 454 may communicate with one or more elements of RAN 410 and/or 412 via an API or other suitable interface. For example, a given external device 454 may provide instructions, requests, etc. to RAN 410 and/or 412 to provide one or more services via one or more respective MECs 414. In some embodiments, such instructions, requests, etc. may include QoS parameters, Service Level Agreements (“SLAs”), etc. (e.g., maximum latency thresholds, minimum throughput thresholds, etc.) associated with the services.

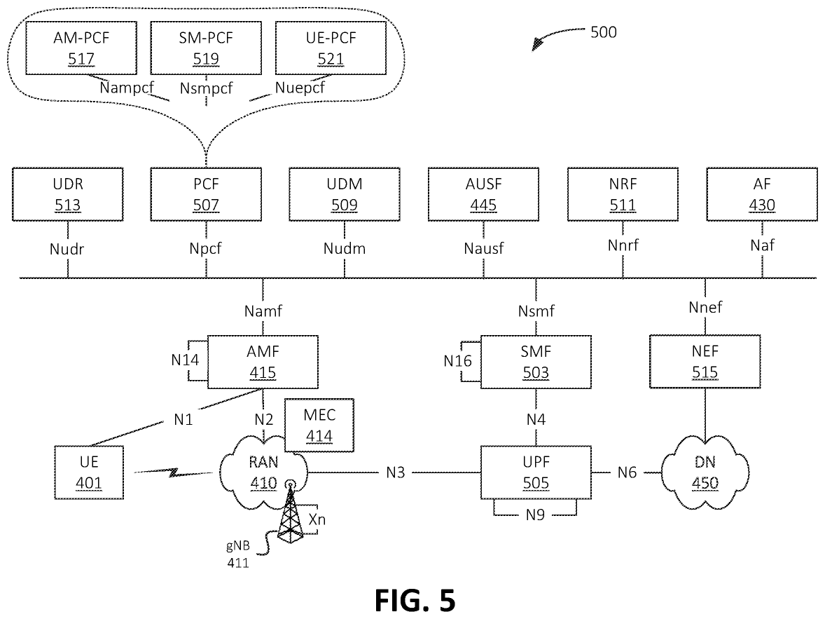

FIG. 5 illustrates another example environment 500, in which one or more embodiments may be implemented. In some embodiments, environment 500 may correspond to a 5G network, and/or may include elements of a 5G network. In some embodiments, environment 500 may correspond to a 5G SA architecture. In some embodiments, environment 500 may include a 5GC, in which 5GC network elements perform one or more operations described herein.

As shown, environment 500 may include UE 401, RAN 410 (which may include one or more gNBs 411 or other types of wireless network infrastructure) and various network functions, which may be implemented as VNFs, CNFs, etc. Such network functions may include AMF 415, SMF 503, UPF 505, PCF 507, UDM 509, AUSF 445, Network Repository Function (“NRF”) 511, AF 430, UDR 513, and NEF 515. Environment 500 may also include or may be communicatively coupled to one or more networks, such as Data Network DN 450.

The example shown in FIG. 5 illustrates one instance of each network component or function (e.g., one instance of SMF 503, UPF 505, PCF 507, UDM 509, AUSF 445, etc.). In practice, environment 500 may include multiple instances of such components or functions. For example, in some embodiments, environment 500 may include multiple “slices” of a core network, where each slice includes a discrete and/or logical set of network functions (e.g., one slice may include a first instance of SMF 503, PCF 507, UPF 505, etc., while another slice may include a second instance of SMF 503, PCF 507, UPF 505, etc.). Additionally, or alternatively, one or more of the network functions of environment 500 may implement multiple network slices. The different slices may provide differentiated levels of service, such as service in accordance with different QoS parameters.

The quantity of devices and/or networks, illustrated in FIG. 5, is provided for explanatory purposes only. In practice, environment 500 may include additional devices and/or networks, fewer devices and/or networks, different devices and/or networks, or differently arranged devices and/or networks than illustrated in FIG. 5. For example, while not shown, environment 500 may include devices that facilitate or enable communication between various components shown in environment 500, such as routers, modems, gateways, switches, hubs, etc. In some implementations, one or more devices of environment 500 may be physically integrated in, and/or may be physically attached to, one or more other devices of environment 500. Alternatively, or additionally, one or more of the devices of environment 500 may perform one or more network functions described as being performed by another one or more of the devices of environment 500.

Elements of environment 500 may interconnect with each other and/or other devices via wired connections, wireless connections, or a combination of wired and wireless connections. Examples of interfaces or communication pathways between the elements of environment 500, as shown in FIG. 5, may include interfaces shown in FIG. 5 and/or one or more interfaces not explicitly shown in FIG. 5. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 500 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 415), an Nudm interface (e.g., indicating communications to be routed to UDM 509), an Npcf interface, an Nupf interface, an Nnef interface, an Nsmf interface, an Nnrf interface, an Nudr interface, an Naf interface, and/or one or more other SBIs. In some embodiments, environment 500 may be, may include, may be implemented by, and/or may be communicatively coupled to core network 107 and/or RAN 103.

UPF 505 may include one or more devices, systems, VNFs, CNFs, etc., that receive, route, process, and/or forward traffic (e.g., user plane traffic). As discussed above, UPF 505 may communicate with UE 401 via one or more communication sessions, such as PDU sessions. Such PDU sessions may be associated with a particular network slice or other suitable QoS parameters, as noted above. UPF 505 may receive downlink user plane traffic (e.g., voice call traffic, data traffic, etc. destined for UE 401) from DN 450, and may forward the downlink user plane traffic toward UE 401 (e.g., via RAN 410). In some embodiments, multiple UPFs 505 may be deployed (e.g., in different geographical locations), and the delivery of content to UE 401 may be coordinated via the N9 interface. Similarly, UPF 505 may receive uplink traffic from UE 401 (e.g., via RAN 410), and may forward the traffic toward DN 450. In some embodiments, UPF 505 may implement, may be implemented by, may be communicatively coupled to, and/or may otherwise be associated with UPF/PGW-U 435. In some embodiments, UPF 505 may communicate (e.g., via the N4 interface) with SMF 503, regarding user plane data processed by UPF 505 (e.g., to provide analytics or reporting information, to receive policy and/or authorization information, etc.).

PCF 507 may include one or more devices, systems, VNFs, CNFs, etc., that aggregate, derive, generate, etc. policy information associated with the 5GC and/or UEs 401 that communicate via the 5GC and/or RAN 410. PCF 507 may receive information regarding policies and/or subscriptions from one or more sources, such as subscriber databases (e.g., UDM 509, UDR 513, etc.), and/or from one or more users such as, for example, an administrator associated with PCF 507. In some embodiments, the functionality of PCF 507 may be split into multiple network functions or subsystems, such as access and mobility PCF (“AM-PCF”) 517, session management PCF (“SM-PCF”) 519, UE PCF (“UE-PCF”) 521, and so on. Such different “split” PCFs may be associated with respective SBIs (e.g., AM-PCF 517 may be associated with an Nampcf SBI, SM-PCF 519 may be associated with an Nsmpcf SBI, UE-PCF 521 may be associated with an Nuepcf SBI, and so on) via which other network functions may communicate with the split PCFs. The split PCFs may maintain information regarding policies associated with different devices, systems, and/or network functions.

NRF 511 may include one or more devices, systems, VNFs, CNFs, etc. that maintain routing and/or network topology information associated with the 5GC. For example, NRF 511 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 513 may include one or more devices, systems, VNFs, CNFs, etc. that provide user and/or subscriber information, based on which PCF 507 and/or other elements of environment 500 may determine access policies, QoS policies, charging policies, or the like. In some embodiments, UDR 513 may receive such information from UDM 509 and/or one or more other sources.

NEF 515 include one or more devices, systems, VNFs, CNFs, etc. that provide access to information, APIs, and/or other operations or mechanisms of the 5GC to devices or systems that are external to the 5GC. NEF 515 may maintain authorization and/or authentication information associated with such external devices or systems, such that NEF 515 is able to provide information, that is authorized to be provided, to the external devices or systems. Such information may be received from other network functions of the 5GC (e.g., as authorized by an administrator or other suitable entity associated with the 5GC), such as SMF 503, UPF 505, a charging function (“CHF”) of the 5GC, and/or other suitable network function. NEF 515 may communicate with external devices or systems (e.g., external devices 454) via DN 450 and/or other suitable communication pathways.

While environment 500 is described in the context of a 5GC, as noted above, environment 500 may, in some embodiments, include or implement one or more other types of core networks. For example, in some embodiments, environment 500 may be or may include a converged packet core, in which one or more elements may perform some or all of the functionality of one or more 5GC network functions and/or one or more EPC network functions. For example, in some embodiments, AMF 415 may include, may implement, may be implemented by, and/or may otherwise be associated with MME 416; SMF 503 may include, may implement, may be implemented by, and/or may otherwise be associated with SGW 417; PCF 507 may include, may implement, may be implemented by, and/or may otherwise be associated with a PCRF (e.g., PCF/PCRF 425); NEF 515 may include, may implement, may be implemented by, and/or may otherwise be associated with a SCEF (e.g., NEF/SCEF 449); and so on.

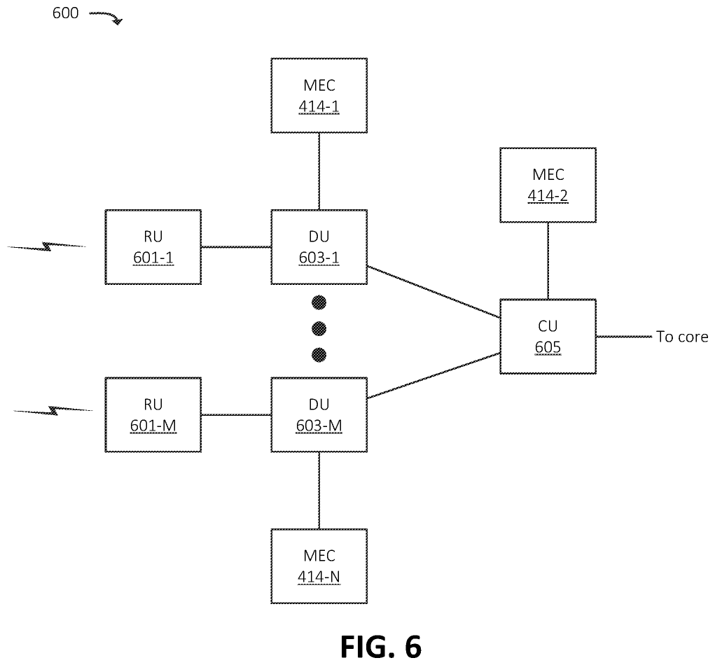

FIG. 6 illustrates an example RAN environment 600, which may be included in and/or implemented by one or more RANs (e.g., RAN 410 or some other RAN). In some embodiments, a particular RAN 410 may include one RAN environment 600. In some embodiments, a particular RAN 410 may include multiple RAN environments 600. In some embodiments, RAN environment 600 may correspond to a particular gNB 411 of RAN 410. In some embodiments, RAN environment 600 may correspond to multiple gNBs 411. In some embodiments, RAN environment 600 may correspond to one or more other types of base stations of one or more other types of RANs. As shown, RAN environment 600 may include CU 605, one or more DUs 603-1 through 603-M (referred to individually as “DU 603,” or collectively as “DUs 603”), and one or more Radio Units (“RUs”) 601-1 through 601-M (referred to individually as “RU 601,” or collectively as “RUs 601”).

CU 605 may communicate with a core of a wireless network (e.g., may communicate with one or more of the devices or systems described above with respect to FIG. 5, such as AMF 415 and/or UPF 505) and/or some other device or system such as MEC 414. In the uplink direction (e.g., for traffic from UEs 401 to a core network), CU 605 may aggregate traffic from DUs 603, and forward the aggregated traffic to the core network. In some embodiments, CU 605 may receive traffic according to a given protocol (e.g., Radio Link Control (“RLC”) traffic) from DUs 603, and may perform higher-layer processing (e.g., may aggregate/process RLC packets and generate Packet Data Convergence Protocol (“PDCP”) packets based on the RLC packets) on the traffic received from DUs 603.

CU 605 may receive downlink traffic (e.g., traffic from the core network, traffic from a given MEC 414, etc.) for a particular UE 401, and may determine which DU(s) 603 should receive the downlink traffic. DU 603 may include one or more devices that transmit traffic between a core network (e.g., via CU 605) and UE 401 (e.g., via a respective RU 601). DU 603 may, for example, receive traffic from RU 601 at a first layer (e.g., physical (“PHY”) layer traffic, or lower PHY layer traffic), and may process/aggregate the traffic to a second layer (e.g., upper PHY and/or RLC). DU 603 may receive traffic from CU 605 at the second layer, may process the traffic to the first layer, and provide the processed traffic to a respective RU 601 for transmission to UE 401.

RU 601 may include hardware circuitry (e.g., one or more RF transceivers, antennas, radios, and/or other suitable hardware) to communicate wirelessly (e.g., via an RF interface) with one or more UEs 401, one or more other DUs 603 (e.g., via RUs 601 associated with DUs 603), and/or any other suitable type of device. In the uplink direction, RU 601 may receive traffic from UE 401 and/or another DU 603 via the RF interface and may provide the traffic to DU 603. In the downlink direction, RU 601 may receive traffic from DU 603, and may provide the traffic to UE 401 and/or another DU 603.

One or more elements of RAN environment 600 may, in some embodiments, be communicatively coupled to one or more MECs 414. For example, DU 603-1 may be communicatively coupled to MEC 414-1, DU 603-M may be communicatively coupled to MEC 414-N, CU 605 may be communicatively coupled to MEC 414-2, and so on. MECs 414 may include hardware resources (e.g., configurable or provisionable hardware resources) that may be configured to provide services and/or otherwise process traffic to and/or from UE 401, via a respective RU 601.

For example, DU 603-1 may route some traffic, from UE 401, to MEC 414-1 instead of to a core network via CU 605. MEC 414-1 may process the traffic, perform one or more computations based on the received traffic, and may provide traffic to UE 401 via RU 601-1. As discussed above, MEC 414 may include, and/or may implement, some or all of the functionality described above with respect to UPF 505, AF 430, and/or one or more other devices, systems, VNFs, CNFs, etc. In this manner, ultra-low latency services may be provided to UE 401, as traffic does not need to traverse DU 603, CU 605, links between DU 603 and CU 605, and an intervening backhaul network between RAN environment 600 and the core network.

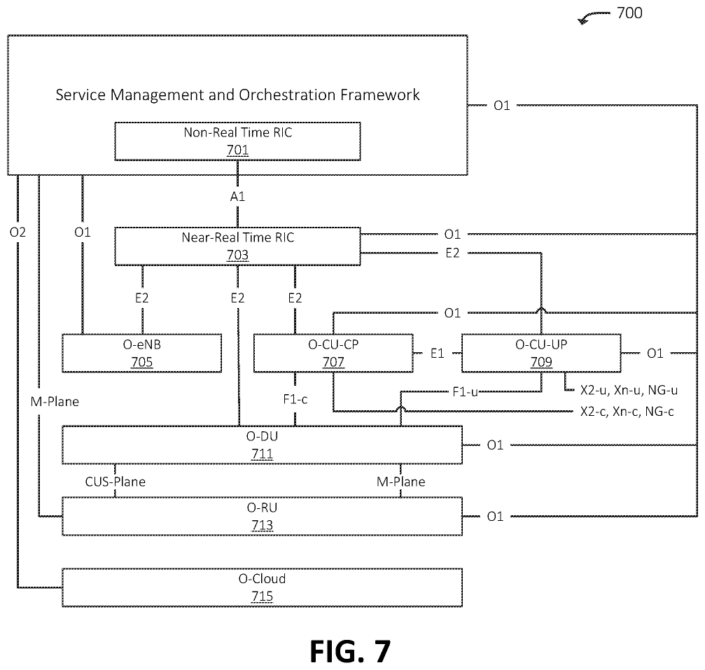

FIG. 7 illustrates an example O-RAN environment 700, which may correspond to RAN 410, RAN 412, and/or RAN environment 600. For example, RAN 410, RAN 412, and/or RAN environment 600 may include one or more instances of O-RAN environment 700, and/or one or more instances of O-RAN environment 700 may implement RAN 410, RAN 412, RAN environment 600, and/or some portion thereof. As shown, O-RAN environment 700 may include Non-Real Time RIC 701, Near-Real Time RIC 703, O-eNB 705, O-CU-Control Plane (“O-CU-CP”) 707, O-CU-User Plane (“O-CU-UP”) 709, O-DU 711, O-RU 713, and O-Cloud 715. In some embodiments, O-RAN environment 700 may include additional, fewer, different, and/or differently arranged components or interfaces.

In some embodiments, some or all of the elements of O-RAN environment 700 may be implemented by one or more configurable or provisionable resources, such as virtual machines, cloud computing systems, physical servers, and/or other types of configurable or provisionable resources. In some embodiments, some or all of O-RAN environment 700 may be implemented by, and/or communicatively coupled to, one or more MECs 414.

Non-Real Time RIC 701 and Near-Real Time RIC 703 may receive performance information (and/or other types of information) from one or more sources, and may configure other elements of O-RAN environment 700 based on such performance or other information. For example, Near-Real Time RIC 703 may receive performance information, via one or more E2 interfaces, from O-eNB 705, O-CU-CP 707, and/or O-CU-UP 709, and may modify parameters associated with O-eNB 705, O-CU-CP 707, and/or O-CU-UP 709 based on such performance information. Similarly, Non-Real Time RIC 701 may receive performance information associated with O-eNB 705, O-CU-CP 707, O-CU-UP 709, and/or one or more other elements of O-RAN environment 700 and may utilize machine learning and/or other higher level computing or processing to determine modifications to the configuration of O-eNB 705, O-CU-CP 707, O-CU-UP 709, and/or other elements of O-RAN environment 700. In some embodiments, Non-Real Time RIC 701 may generate machine learning models based on performance information associated with O-RAN environment 700 or other sources, and may provide such models to Near-Real Time RIC 703 for implementation. In some embodiments, Non-Real Time RIC 701 and/or Near-Real Time RIC 703 may provide (either directly or indirectly) RAN KPIs to RCDS 109, based on which RCDS 109 may identify RAN conditions such as congestion conditions or other types of potential connectivity issues.

O-eNB 705 may perform functions similar to those described above with respect to gNB 411 and/or eNB 413. For example, O-eNB 705 may facilitate wireless communications between UE 401 and a core network. O-CU-CP 707 may perform control plane signaling to coordinate the aggregation and/or distribution of traffic via one or more DUs 603, which may include and/or be implemented by one or more O-DUs 711, and O-CU-UP 709 may perform the aggregation and/or distribution of traffic via such DUs 603 (e.g., O-DUs 711). O-DU 711 may be communicatively coupled to one or more RUs 601, which may include and/or may be implemented by one or more O-RUs 713. In some embodiments, O-Cloud 715 may include or be implemented by one or more MECs 414, which may provide services, and may be communicatively coupled, to O-CU-CP 707, O-CU-UP 709, O-DU 711, and/or O-RU 713 (e.g., via an O1 and/or O2 interface).

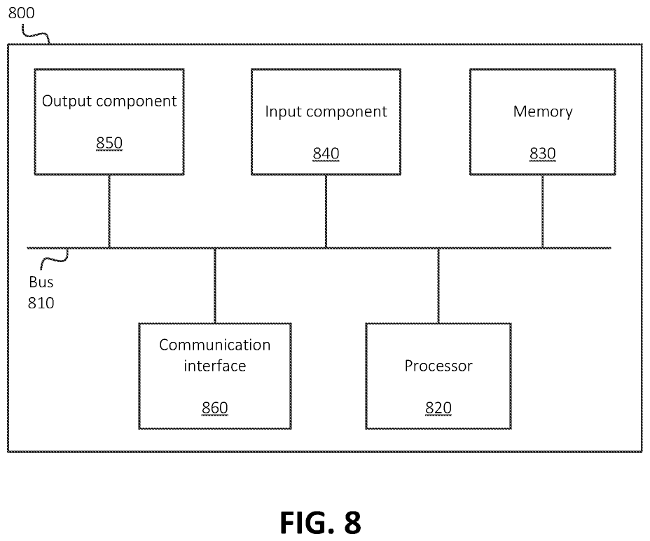

FIG. 8 illustrates example components of device 800. One or more of the devices described above may include one or more devices 800. Device 800 may include bus 810, processor 820, memory 830, input component 840, output component 850, and communication interface 860. In another implementation, device 800 may include additional, fewer, different, or differently arranged components.

Bus 810 may include one or more communication paths that permit communication among the components of device 800. Processor 820 may include a processor, microprocessor, a set of provisioned hardware resources of a cloud computing system, or other suitable type of hardware that interprets and/or executes instructions (e.g., processor-executable instructions). In some embodiments, processor 820 may be or may include one or more hardware processors. Memory 830 may include any type of dynamic storage device that may store information and instructions for execution by processor 820, and/or any type of non-volatile storage device that may store information for use by processor 820.

Input component 840 may include a mechanism that permits an operator to input information to device 800 and/or other receives or detects input from a source external to input component 840, such as a touchpad, a touchscreen, a keyboard, a keypad, a button, a switch, a microphone or other audio input component, etc. In some embodiments, input component 840 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 850 may include a mechanism that outputs information to the operator, such as a display, a speaker, one or more light emitting diodes (“LEDs”), etc.

Communication interface 860 may include any transceiver-like mechanism that enables device 800 to communicate with other devices and/or systems (e.g., via RAN 410, RAN 412, DN 450, etc.). For example, communication interface 860 may include an Ethernet interface, an optical interface, a coaxial interface, or the like. Communication interface 860 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 800 may include more than one communication interface 860. For instance, device 800 may include an optical interface, a wireless interface, an Ethernet interface, and/or one or more other interfaces.

Device 800 may perform certain operations relating to one or more processes described above. Device 800 may perform these operations in response to processor 820 executing instructions, such as software instructions, processor-executable instructions, etc. stored in a computer-readable medium, such as memory 830. A computer-readable medium may be defined as a non-transitory memory device. A memory device may include space within a single physical memory device or spread across multiple physical memory devices. The instructions may be read into memory 830 from another computer-readable medium or from another device. The instructions stored in memory 830 may be processor-executable instructions that cause processor 820 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-3), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
monitor Key Performance Indicators (“KPIs”) of a radio access network (“RAN”) that implements a first radio access technology (“RAT”);
determine, based on monitoring the KPIs of the RAN, that a particular RAN condition has occurred; and
notify a Fixed Wireless Access (“FWA”) device, that is wirelessly connected to the RAN via the first RAT and that is also wirelessly connected to a plurality of client devices via a second RAT, that the particular RAN condition has occurred,
wherein the FWA device implements one or more policies for communications between the FWA device and the plurality of client devices based on receiving the notification that the particular RAN condition has occurred.

2. The device of claim 1, wherein one or more processors are further configured to:
provide the one or more policies to the FWA device via the particular RAN.

3. The device of claim 1,
wherein the first RAT includes at least one of:
a Fifth Generation (“5G”) RAT, or
a Long-Term Evolution (“LTE”) RAT; and
wherein the second RAT includes a WiFi RAT.

4. The device of claim 1, wherein the KPIs of the RAN include one or more KPIs that are not detectable by the FWA device.

5. The device of claim 1, wherein the KPIs of the RAN include at least one of:
a quantity of User Equipment (“UEs”) connected to one or more base stations of the RAN,
an amount of available radio resources of the RAN,
a measure of latency between the one or more base stations of the RAN and one or more UEs that are connected to the one or more base stations,
a measure of throughput between the one or more base stations of the RAN and one or more UEs that are connected to the one or more base stations, or
a measure of jitter between the one or more base stations of the RAN and one or more UEs that are connected to the one or more base stations.

6. The device of claim 1, wherein implementing the one or more policies includes at least one of:
implementing a maximum throughput for one or more client devices, of the plurality of client devices,
implementing a minimum throughput for one or more client devices, of the plurality of client devices, or
implementing a minimum latency for one or more client devices, of the plurality of client devices.

7. The device of claim 1, wherein the one or more policies include particular criteria and a particular set of thresholds for client devices that meet the particular criteria, wherein implementing the one or more policies includes:
identifying that a particular client device, of the plurality of client devices, meets the particular criteria; and
implementing the particular set of thresholds for communications between the FWA device and the particular client device based on identifying that the particular client device meets the particular criteria.

8. A device, comprising:
one or more processors configured to:
connect to a radio access network (“RAN”) via a first radio access technology (“RAT”);
connect to a plurality of client devices via a second RAT;
receive one or more policies for communications with the plurality of client devices via the second RAT;
receive a notification, wherein the notification is determined based on Key Performance Indicators (“KPIs”) associated with the RAN; and
implement the one or more policies for communications with the plurality of client devices based on the notification.

9. The device of claim 8, wherein the notification is provided to the device based on a determination that a particular RAN condition has occurred with respect to the first RAN, wherein the determination that the particular RAN condition has occurred is based on monitoring the KPIs associated with the RAN.

10. The device of claim 8, wherein the one or more processors are further configured to:
route communications, received via the RAN, to one or more client devices of the plurality of client devices via the second RAT; and
route communications, received from the one or more client devices via the second RAT, to the RAN.

11. The device of claim 8,
wherein the first RAT includes at least one of:
a Fifth Generation (“5G”) RAT, or
a Long-Term Evolution (“LTE”) RAT; and
wherein the second RAT includes a WiFi RAT.

12. The device of claim 8, wherein the KPIs of the RAN include one or more KPIs that are not detectable by the device.

13. The device of claim 8, wherein the KPIs of the RAN include at least one of:
a quantity of User Equipment (“UEs”) connected to one or more base stations of the RAN,
an amount of available radio resources of the RAN,
a measure of latency between the one or more base stations of the RAN and one or more UEs that are connected to the one or more base stations,
a measure of throughput between the one or more base stations of the RAN and one or more UEs that are connected to the one or more base stations, or
a measure of jitter between the one or more base stations of the RAN and one or more UEs that are connected to the one or more base stations.

14. The device of claim 8, wherein implementing the one or more policies includes at least one of:
implementing a maximum throughput for one or more client devices, of the plurality of client devices,
implementing a minimum throughput for one or more client devices, of the plurality of client devices, or
implementing a minimum latency for one or more client devices, of the plurality of client devices.

15. A method, comprising:
monitoring Key Performance Indicators (“KPIs”) of a radio access network (“RAN”) that implements a first radio access technology (“RAT”);
determining, based on monitoring the KPIs of the RAN, that a particular RAN condition has occurred; and
notifying a Fixed Wireless Access (“FWA”) device, that is wirelessly connected to the RAN via the first RAT and that is also wirelessly connected to a plurality of client devices via a second RAT, that the particular RAN condition has occurred,
wherein the FWA device implements one or more policies for communications between the FWA device and the plurality of client devices based on receiving the notification that the particular RAN condition has occurred.

16. The method of claim 15,
wherein the first RAT includes at least one of:
a Fifth Generation (“5G”) RAT, or
a Long-Term Evolution (“LTE”) RAT; and
wherein the second RAT includes a WiFi RAT.

17. The method of claim 15, wherein the KPIs of the RAN include one or more KPIs that are not detectable by the FWA device.

18. The method of claim 15, wherein the KPIs of the RAN include at least one of:
a quantity of User Equipment (“UEs”) connected to one or more base stations of the RAN,
an amount of available radio resources of the RAN,
a measure of latency between the one or more base stations of the RAN and one or more UEs that are connected to the one or more base stations,
a measure of throughput between the one or more base stations of the RAN and one or more UEs that are connected to the one or more base stations, or
a measure of jitter between the one or more base stations of the RAN and one or more UEs that are connected to the one or more base stations.

19. The method of claim 15, wherein implementing the one or more policies includes at least one of:
implementing a maximum throughput for one or more client devices, of the plurality of client devices,
implementing a minimum throughput for one or more client devices, of the plurality of client devices, or
implementing a minimum latency for one or more client devices, of the plurality of client devices.

20. The method of claim 15, wherein the one or more policies include particular criteria and a particular set of thresholds for client devices that meet the particular criteria, wherein implementing the one or more policies includes:
identifying that a particular client device, of the plurality of client devices, meets the particular criteria; and
implementing the particular set of thresholds for communications between the FWA device and the particular client device based on identifying that the particular client device meets the particular criteria.
